(19) United States
(12) Patent Application Publication
(10) Pub. No.: US 2006/0250968 A1
(43) Pub. Date: Nov. 9, 2006

(54) Network access protection

(75) Inventors: Efim Hudis, Bellevue, WA (US); Ron Mondri, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/120,759

(22) Filed: May 3, 2005

(51) Int. Cl. H04J 3/14; H04J 1/16; H04L 1/00; H04L 12/26; H04L 12/28; H04J 3/22; H04J 3/16

(52) U.S. Cl. 370/241; 370/465

(57) ABSTRACT

A network access protection method includes creating an access policy as a function of statement-of-health information. The network access protection method also includes selectively allowing, denying or redirecting communications based upon the access policy and the current statement-of-health of one or more computing devices associated with the communications.

### BACKGROUND

Computer networks are subject to ever increasing security risks. To protect against attacks and prevent security breaches, firewalls are utilized to control the flow of communications within networks. More specifically, communications received by the firewall are selectively permitted to pass through in accordance with one or more defined rules. The access rules enforced by firewalls are a function of one or more network provisioning and traffic parameters, such as source or destination domain names (e.g., URL), internet protocol addresses (IP addresses), communication channel (e.g., port), application protocols (e.g., HTTP, FTP) and/or security credentials (e.g., secure logon and authentication certificate).

However, access rules based upon the above network provisioning and traffic parameters are problematic. The network provisioning and traffic based rules are static, but some parameters do change frequently. Furthermore, the effectiveness of protecting against attacks and the impact upon users is dependent upon the level of granularity of the access rules. However, access rules with sufficient granularity are typically impractical to deploy and maintain on most networks. Accordingly, one or more of the computing devices and/or networks are often vulnerable. Furthermore, the deployed access rules may substantially impact the performance of the computing device and/or networks. Thus, conventional access rules based upon network provisioning and traffic parameters may have a significant and sometimes debilitating effect on users.

### SUMMARY

The techniques described herein are directed toward network access protection methods and systems. In one embodiment, an access policy is defined in terms of statement-of-health based rules. The access policy may also be defined in terms of network provisioning and traffic parameter based rules. The access policy may be applied to communications between computing device, based upon the current statement-of-health of one or more of the computing devices. The current statement-of-health may include the state of one or more criteria such as installed applications, installed patches, configurations, device performance and hardware components.

### BRIEF DESCRIPTION OF THE DRAWINGS

Embodiments are illustrated by way of example and not by way of limitation, in the figures of the accompanying drawings and in which like reference numerals refer to similar elements and in which:

FIG. 1 shows a block diagram of an exemplary operating environment for implementing a network access protection system.

FIG. 2 shows a flow diagram of a network access protection method.

FIG. 3 shows a flow diagram of network access protection method.

FIG. 4 shows a block diagram of an exemplary operating architecture for implementing a network access protection system.

FIG. 5 shows a block diagram of an exemplary operating architecture for implementing a network access protection method.

### DETAILED DESCRIPTION

Reference will now be made in detail to particular embodiments, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description, numerous specific details are set forth in order to provide a thorough understanding. However, it is understood that the present invention may be practiced without these specific details. In other instances, well-known methods, procedures, components, and circuits have not been described in detail as not to unnecessarily obscure aspects of the present invention.

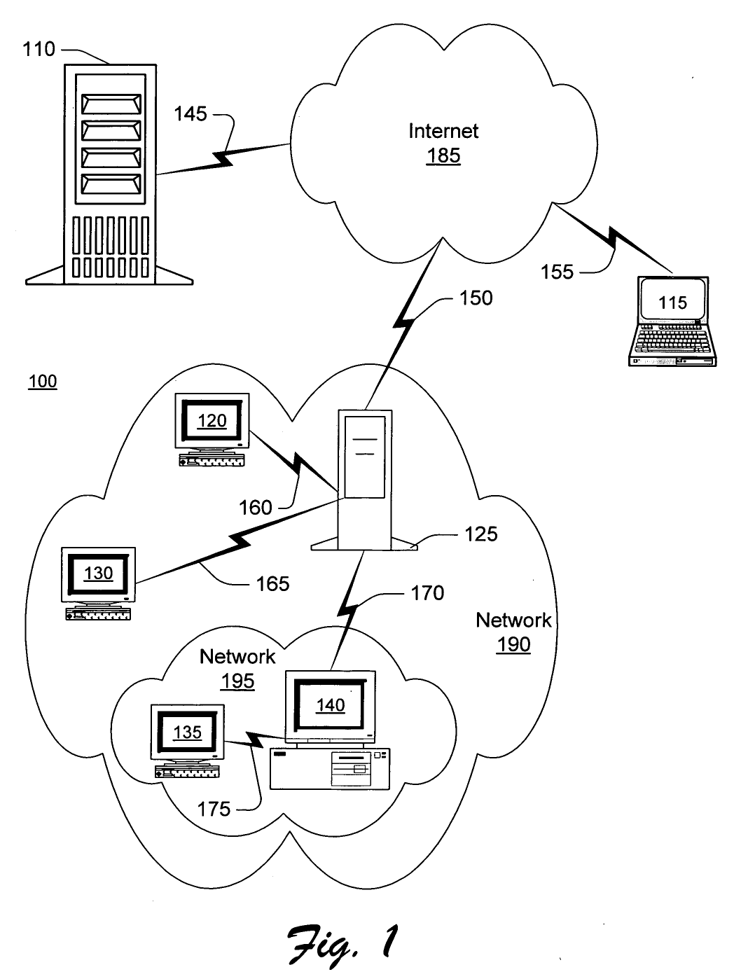

FIG. 1 shows an exemplary operating environment 100 for implementing a network access protection system. The operating environment 100 includes a plurality of computing devices 110-140 interconnected by one or more communication channels 145-175. The computing devices may include personal computers, server computers, client devices, routers, switches, wireless access points, security appliances, hand-held or laptop devices, set top boxes, programmable consumer electronics, minicomputers, mainframe computers, or the like. Various computing devices 110-140 may be related such that they form one or more networks 185-195. The networks 185-195 may include local area networks, wide area networks, intranets, extranets, the Internet and/or the like.

One or more trust boundaries within the exemplary computing environment (e.g., at computing device 125) are utilized to control the flow of communications between computing devices 110-140 as a function of a statement-of-health of one or more of the computing devices 110-140. The trust boundary may be disposed between computing devices 110-140, between one or more computing devices 110-140 and one or more networks 185-195, and/or between networks 185-195. A trust boundary may be implemented by a dedicated computing device (e.g., a security appliance) or by an application (e.g., firewall) running on a computing device.

Cross-boundary communications are controlled as a function of the statement-of-health of one or more of the computing devices 110-1140. The statement-of-health of a computing device 140 is a measure of the trustworthiness of the computing device 140. More specifically, the statement-of-health indicates the computing device's 140 status with respect to criteria such as installed applications, installed patches, configurations, device performance, hardware components and/or the like. A computing device 140 is healthy if its statement-of-health conforms to some security policy in effect on some network, and is unhealthy otherwise. For example, the statement-of-health may indicate each application loaded on a given computing device, such as operating system, browser, antivirus program and the like. The statement-of-health may also indicate the latest service packs, patches, virus definition and the like installed for each application. The statement-of-health may also indicate a device performance parameter, such as level of network traffic, processor utilization, or the like. The statement-of-health may also indicate the presence of a particular hardware component offering particular functionality, such as an integrated circuit providing an embedded security feature.

A given trust boundary applies one or more statement-of-health based access rules to cross-boundary communications passing through the trust boundary. For example, a trust boundary may be disposed at computing device 125 between a first computing device 115 and a second computing device 130. The first computing device 115 may request a resource that is provided by the second computing device 130. The communication traffic associated with the request is received by the trust boundary at computing device 125. The trust boundary selectively allows the request to be routed to the second computing device 130 (e.g., the requested resource) based upon the statement-of-health of the first computing device 115, the statement-of-health of the second computing device 130 (e.g., the intended destination), or both. In particular, if the first computing device 115 and/or the second computing device 130 are currently healthy, the communication associated with the request is routed to the second computing device 130. If the first computing device 115 and/or the second computing device 130 are currently unhealthy, the communication may be blocked, further filtered, limited or re-routed to another resource (e.g., a third computing device 110).

Accordingly, if the computing devices 115, 130 are healthy, communications between the two are permitted. Thus, users of the computing devices 115, 130 are not impacted. However, if either of the computing devices 115, 130 are unhealthy, the spread of malicious software between the computing device 115, 130 may be prevented by blocking or further filtering the communications between the devices 115, 130. The vulnerability represented by the unhealthy device 115 may also be eliminated by pushing the unhealthy computing device 115 to a resource on a third computing device 110 where the unhealthy device 115 may be updated (e.g., a security patch installed).

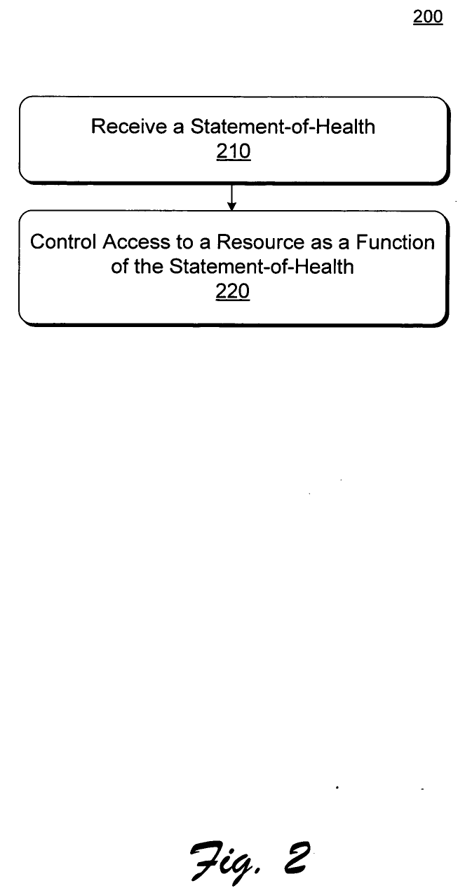

FIG. 2 shows a flow diagram of a network access protection process 200, which can be implemented at a trust boundary. At 210, a statement-of-health of one or more computing devices is received. In one implementation, the statement-of-health of the source computing device requesting a resource may be generated, collected or made otherwise made available. In another implementation, the statement-of-health of the intended destination computing device for satisfying the request may be generated, collected or made otherwise made available. In yet another implementation, the statement-of-health of both the source computing device and the destination device may be generated, collected or made otherwise made available.

The statement-of-health is a measure of the trustworthiness of the computing device. More specifically, the statement-of-health indicates the status of the corresponding computing device with respect to criteria such as installed applications, installed patches, configurations, device performance, hardware components and/or the like. The degree of a computing device's health is determined based upon the extent to which it conforms to a specified set of criteria. In particular, a computing device is healthy if its statement-of-health conforms to some current set of criteria and is unhealthy otherwise. In the later case, the statement-of-health may include data indicating the reasons the computing device is unhealthy.

At 220, access to a resource is controlled as a function of the statement-of-health. For example, if the source computing device and the destination computing device are healthy the communication is permitted. If the source computing device and/or destination computing device are unhealthy, communications between the computing devices may be blocked. Alternatively, communications between the computing devices may be filtered or otherwise limited as a function of one or more conventional provisioning and traffic parameters, such as domain names (e.g., URL), internet protocol addresses (IP addresses), communication channel (e.g., port), application protocols (e.g., HTTP, FTP) and/or security credentials (e.g., secure logon and authentication certificate) and/or the like. Filtering may also be based upon the data indicating the reasons why a particular computing device is unhealthy.

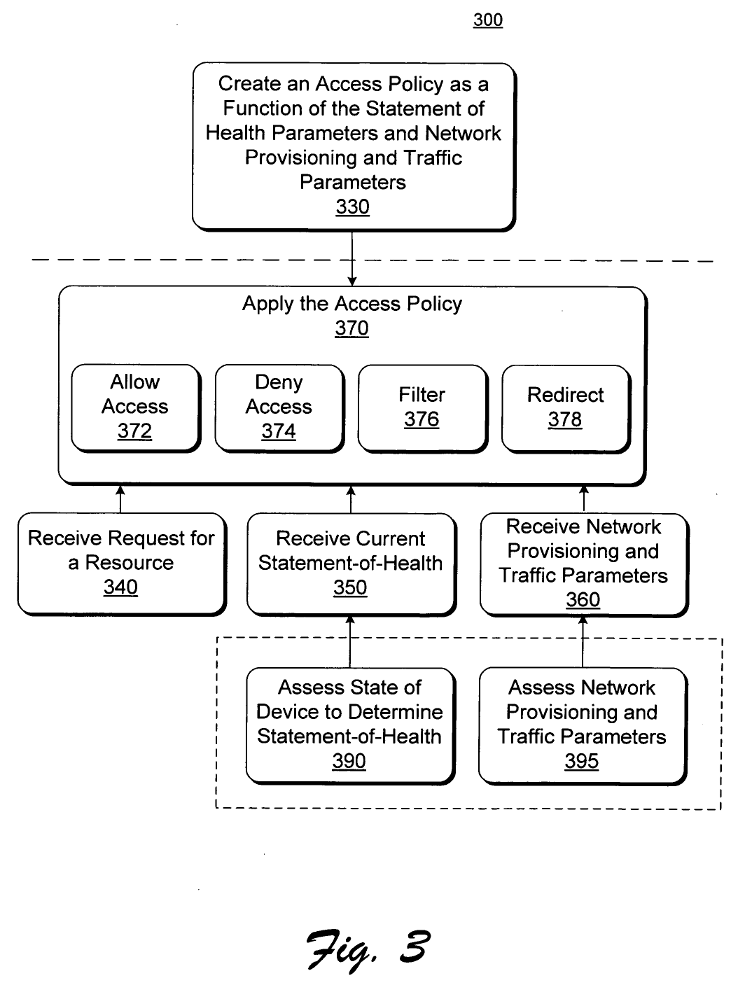

FIG. 3 shows a flow diagram of network access protection process 300, which can be implemented at a trust boundary. The process includes creation of an access policy 330 and application of the access policy 340, 350, 360, 370. More specifically, an access policy may be defined in terms of a statement-of-health of a source computing device, a statement-of-health of a destination computing device, or both, at 330. The access policy may be further defined in terms of conventional network provisioning and traffic parameters, such as domain names (e.g., URL), internet protocol addresses (IP addresses), communication channel (e.g., port), application protocols (e.g., HTTP, FTP), security credentials (e.g., secure logon and authentication certificate) and/or the like. The access policy may then be utilized to control communications between computing devices.

Enforcing the access policy begins upon receipt of a request for a resource (e.g., receipt of a cross-boundary communication), at 340. The request for the resource is received from a source computing device, and the requested resource is to be provided by a destination computing device. At 350, a current statement-of-health associated with the request is received. The statement-of-health may be based upon the source computing device, the destination computing device, and/or both. At optional process 360, one or more network provisioning and traffic parameters pertaining to the request may also be received.

The statement-of-health information 390 and the network provisioning and traffic parameters 395 may be generated, collected or otherwise made available any number of ways. In one implementation, the statement-of-health for each computing device may be assessed as an integral part of the network access protection process. In another implementation, a separate process may determine the statement-of-health of each computing device. Similarly, the one or more network provisioning and traffic parameters may be assessed as an integral part of the network access protection process and/or in a separate process. The network access protection process, assessment of statement-of-health assessment and/or network provisioning and traffic parameter assessment may be implemented by the same computing and/or electronic device or distributed over one or more computing and/or electronic devices.

At 370, a determination of whether or not the request is forwarded to the intended destination computing device is made based upon the access policy and the current statement-of-heath of the source computing device and/or the destination computing device. In particular, if the current statement-of-health of the source computing device and/or the statement-of-health of the intended destination computing device are indicative of a healthy state, the request is forwarded to the intended destination, at 372. If the current statement-of-health of the source computing device and/or the intended destination computing device is indicative of an unhealthy state, the communication traffic of the request may be dropped, at 374. In another implementation, if the current statement-of-health of the source computing device and/or the intended destination computing device is indicative of an unhealthy state, the request may be filtered or limited according to one or more conventional network provisioning and traffic parameters, at 376. In yet another implementation, if the current statement-of-health of the source computing device and/or the intended destination computing device is indicative of an unhealthy state the request may be redirected, at 378. The request may be redirected by pushing the source and/or destination computing device to an appropriate resource for updating the state of the device. For example, the source computing device may be redirected to a server where its operating system may be updated with a current security patch.

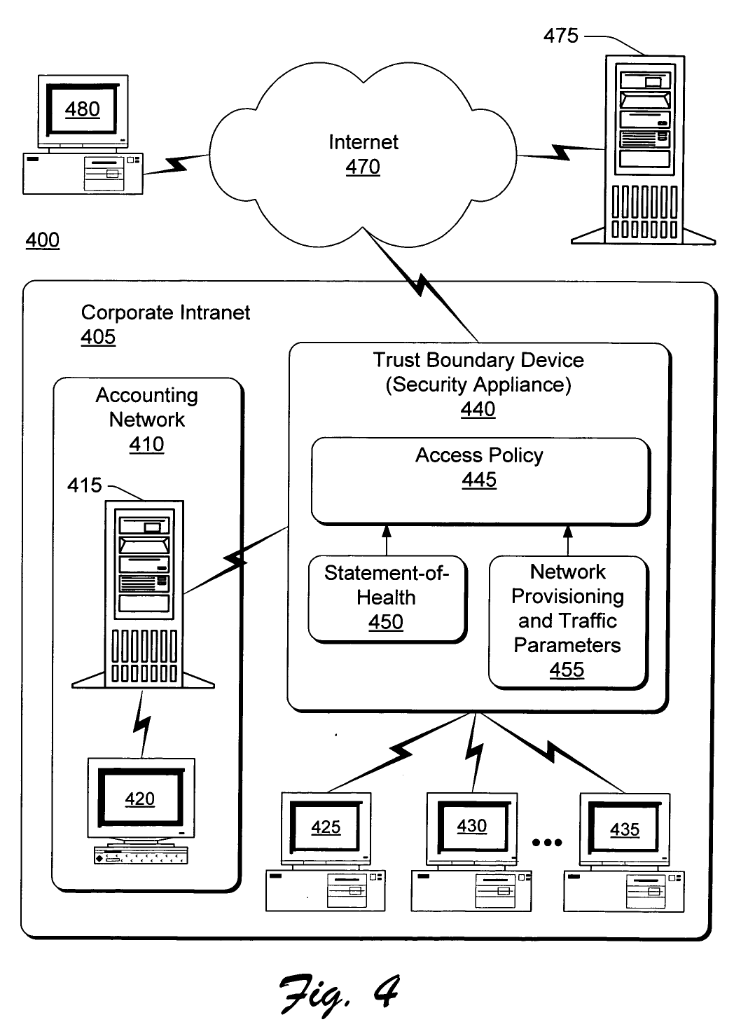

FIG. 4 shows an exemplary operating architecture 400 for implementing a network access protection system. The exemplary operating architecture 400 includes a corporate wide network (e.g., intranet) 405, an accounting department network 410, the Internet 470 (e.g., World Wide Web), and various computing devices 415-435, 440, 475, 480. The corporate intranet 405 includes a plurality of computing devices 415-440. Some of the computing devices 415, 420 of the corporate intranet 405 constitute the accounting department network 410. A trust boundary device (e.g., security appliance) 440 is disposed between the Internet 470 and the corporate intranet 405. The trust boundary device 440 is also disposed between the accounting department network 410 and the other computing devices 425-435 of the corporate intranet 405.

The trust boundary device 440 is adapted to control cross-boundary communications based upon the statement-of-health of the destination computing device, the statement-of-health of the source computing device, or both. For example, an access policy may selectively deny access to a client computer 435 requesting access to a payroll server 415 if the client computer 435 is unhealthy (e.g., a service pack for a spreadsheet application is not installed on the source resource 435).

In one implementation, enforcement of the access policy may block a source computing device from accessing common and/or frequently used resources of a destination computing device if the source computing device is unhealthy. In another implementation, enforcement of the access policy may allow limited access to a destination computing device. In another implementation, enforcement of an access policy may include redirecting a user of an unhealthy computing device to a resource on another computing device, where the user may update the unhealthy computing device. For example, a trust boundary device 440 acting as a web-proxy may prevent a user from accessing the Internet 470 by checking the statement-of-health of the user's computing device 435 and blocking the access to the internet 470 (e.g., web-access quarantine) if the machine is unhealthy (e.g., is not running an antivirus application or the virus definitions are not up-to-date). The trust boundary device 440 may also in this case redirect the user to an appropriate website where the user can update his/her computing device 435.

The access policy enforced by the trust boundary device 440 includes access control rules based upon the statement-of-health of one or more of the computing devices 415-435, 475, 480. The access control rules protect against attacks and prevent security breaches. For example, a vulnerability may be exploited through communications utilizing the TCP protocol on port NNN. An appropriate statement-of-health based access rule may be: If destination machine is healthy allow TCP traffic on port NNN. If destination machine is unhealthy block inbound TCP traffic on port NNN. The access control rules may also be based upon conventional network provisioning and traffic parameters. For example, a vulnerability may be exploited through a web browser component. The appropriate statement-of-health based access rule may be: If source is healthy allow unrestricted access to the web. If the source machine is unhealthy, run all HTTP traffic through a filter that strips potentially hazardous parts of HTML pages (e.g., all scripts). Furthermore, it is appreciated that a device may be healthy for a first purpose and unhealthy for another purpose. For example, a device may be healthy for accessing e-mails but unhealthy for accessing a main file server where client files are stored. Thus, the appropriate statement-of-health based access rule may be: If device is healthy allows all requests. If device is unhealthy allow access to e-mail server and block access to main file server. In the above examples, the negative impact of filters using conventional network provisioning and traffic parameters (e.g., strip all potential hazardous part of HTML pages or block all TCP traffic on port NNN) is mitigated by the fact that the access policy is based upon the statement-of-health of one or more appropriate computing devices.

The statement-of-health information may be generated, collected or otherwise made available to the trust boundary device 440 any number of ways. In one implementation, the trust boundary device 440 may determine the statement-of-health for each computing device 415-435, 475, 480. In another implementation, a separate entity may determine the statement-of-health of each computing device 415-435, 475, 480. In yet another implementation, the statement-of-health of a given computing device 415 may be reported by the given computing device 415. The trust boundary device 440 may then query the separate entity for a given computing device's statement-of-health status. In one implementation, the statement-of-health information may be stored in a table containing a full-bill of health for each computing device 415-435, 475, 480. In another implementation, the statement-of-health information for each computing device may be stored as a single bit (e.g., a flag) indicative of the current state of the computing device (e.g., “0” of healthy and “1” if unhealthy).

Generally, any of the functions, processes of the network access protection methods and systems described above can be implemented using software, firmware, hardware, or any combination of these implementations. The term “logic, “module” or “functionality” as used herein generally represents software, firmware, hardware, or any combination thereof. For instance, in the case of a software implementation, the term “logic,” “module,” or “functionality” represents computer-executable program code that performs specified tasks when executed on a computing device or devices. The program code can be stored in one or more computer-readable media (e.g., computer memory). It is also appreciated that the illustrated separation of logic, modules and functionality into distinct units may reflect an actual physical grouping and allocation of such software, firmware and/or hardware, or can correspond to a conceptual allocation of different tasks performed by a single software program, firmware routine or hardware unit. The illustrated logic, modules and functionality can be located at a single site, or can be distributed over a plurality of locations.

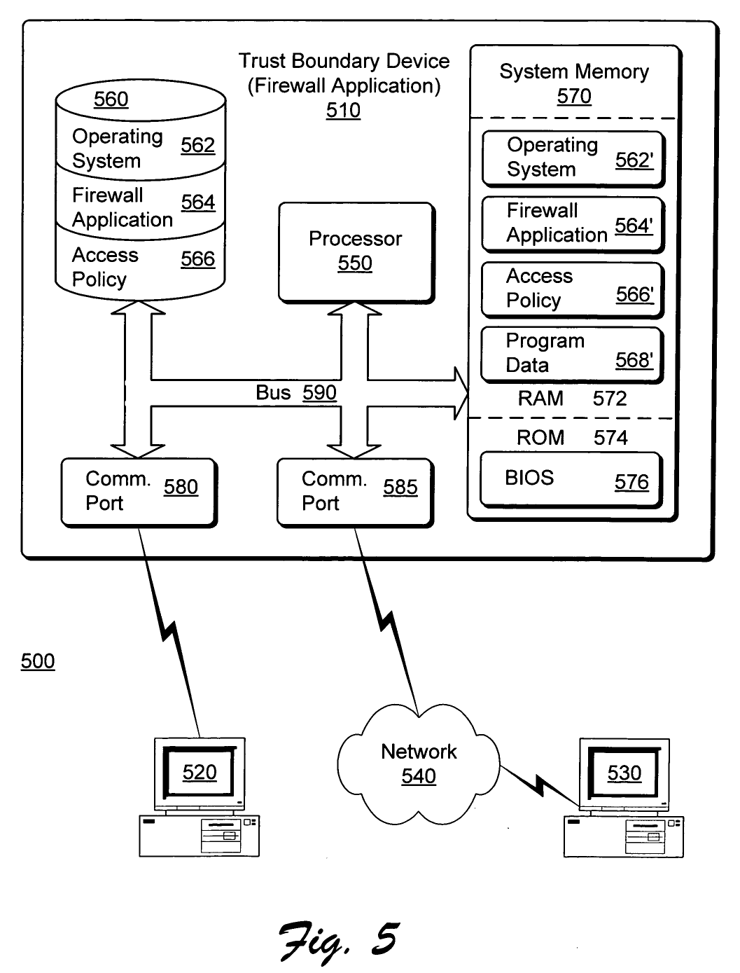

FIG. 5 shows an exemplary operating architecture 500 for implementing a network access protection system. The exemplary operating environment 500 includes a trust boundary device 510 communicatively disposed between a plurality of computing devices 520-530. The trust boundary device 510 may be implemented by a dedicated computing device (e.g., security appliance) or as an application running on a computing device, such as a server computer, router, wireless access point, personal computer, client device, hand-held or laptop device, multiprocessor system, microprocessor-base system, set top box, programmable consumer electronic, minicomputer, mainframe computer, or the like.

An exemplary trust boundary device 510 may include one or more processors 550, one or more computer-readable media 560, 570 and one or more communication ports 580, 585 communicatively coupled to each other. The computer-readable media 560, 570 and communication ports 580, 585 may be communicatively coupled to the one or more processors 550 by one or more buses 590. The one or more buses 590 may be implemented using any kind of bus structure or combination of bus structures, including a system bus, a memory bus or memory controller, a peripheral bus, an accelerated graphics port, and a processor or local bus using any of a variety of bus architectures. It is appreciated that the one or more buses 590 provide for the transmission of computer-readable instructions, data structures, program modules, and other data encoded in one or more modulated carrier waves. Accordingly, the one or more buses 590 may also be characterized as computer-readable media.

Although not shown, the trust boundary device 510 may include additional input/output devices, such as a display device, a keyboard, and a pointing device (e.g., a “mouse”). The input/output devices may further include speakers, microphone, printer, joystick, game pad, satellite dish, scanner, card reading devices, digital or video camera, or the like. The input/output devices may be coupled to the system bus 590 through any kind of input/output interface and bus structures, such as a parallel port, serial port, game port, universal serial bus (USB) port, video adapter or the like.

The computer-readable media 560, 570 may include system memory 570 and one or more mass storage devices 560. The mass storage devices 560 may include a variety of types of volatile and non-volatile media, each of which can be removable or non-removable. For example, the mass storage devices 560 may include a hard disk drive for reading from and writing to a non-removable, non-volatile magnetic media. The one or more mass storage devices 560 may also include a magnetic disk drive for reading from and writing to a removable, non-volatile magnetic disk (e.g., a “floppy disk”), and/or an optical disk drive for reading from and/or writing to a removable, non-volatile optical disk such as a compact disk (CD), digital versatile disk (DVD), or other optical media. The mass storage devices 560 may further include other types of computer-readable media, such as magnetic cassettes or other magnetic storage devices, flash memory cards, electrically erasable programmable read-only memory (EEPROM), or the like. Generally, the mass storage devices 560 provides for non-volatile storage of computer-readable instructions, data structures, program modules, and other data for use by the computing device 510. For instance, the mass storage device 560 may store the operating system 562, the firewall application 564, the access policy 566, and other program modules and data.

The system memory 570 may include both volatile and non-volatile media, such as random access memory (RAM) 572, and read only memory (ROM) 574. The ROM 574 typically includes an input/output system (BIOS) 576 that contains the basic routines that help to transfer information between elements within the trust boundary device 510, such as during start-up. The BIOS 576 instructions executed by the processor, for instance, causes the operating system 562 to be loaded from the mass storage devices 560 into the RAM 570. The BIOS 576 then causes the processor 550 to begin executing the operating system 562′ from the RAM 570. The firewall application 564 and the access policy 566 may then be loaded into the RAM 570 under control of the operating system 562′

Computing devices 520, 530 may be directly or indirectly communicatively coupled to the communication ports 580, 585 of the trust boundary device 510. Accordingly, the trust boundary device 510 may operate as an access control point using physical and/or logical connections to one or more networks 540, remote computing devices 520, 530, or the like. The communication ports 580, 585 of the trust boundary device 510 may include any type of network interface, such as a network adapter, modem, radio transceiver, or the like. The communication ports 580, 585 may implement any connectivity strategies, such as broadband connectivity, modem connectivity, digital subscriber link DSL connectivity, wireless connectivity or the like. It is appreciated that the communication ports 580, 585 and the communication channels that couple the computing device 520, 530 to the communication ports 580, 585 provide for the transmission of computer-readable instructions, data structures, program modules, and other data encoded in one or more modulated carrier waves (e.g., communication signals) over one or more communication channels. Accordingly, the one or more communication port 580, 585 and/or communication channels may also be characterized as computer-readable media.

The networks 540 may include an intranet, an extranet, the Internet, a wide-area network (WAN), a local area network (LAN), and/or the like. The computing devices 520, 530 may include any kind of electronic or computer equipment, including personal computers, server computers, hand-held or laptop devices, multiprocessor systems, microprocessor-base systems, set top boxes, game consoles, programmable consumer electronics, network PCs, minicomputers, mainframe computers, routers and/or the like. The networks 540 and computing devices 520, 530 may include all of the features discussed above with respect to the trust boundary device 510, or some subset thereof.

The processor 550 of the trust boundary device 510 executes various instructions of the firewall application 564′ to control the communications between the computing devices 520, 530 coupled to the communication ports 580, 585. In particular, the firewall application 564′ may provide for defining an access policy for the computing architecture 500. Alternative the firewall application 564′ may receive an access policy that has been defined by another application, program module or the like. The access policy includes one or more access control rules based upon the statement-of-health of a source computing device 520 and/or an intended destination computing device 530. The access policy may also include one or more filters based upon conventional network provisioning and traffic parameters, such as domain names (e.g., URL), internet protocol addresses (IP addresses), communication channel (e.g., port), application protocols (e.g., HTTP, FTP), security credentials (e.g., secure logon and authentication certificate) and/or the like

The firewall application 564′ enforces the access policy against communications between the computing devices 520, 530 that pass through the trust boundary device 510. More specifically, a determination is made as to whether a request should be forwarded to the intended destination computing device 530. The determination is made based upon the access policy and a current statement-of-health associated with the source computing device 520 and/or current statement-of-health associated with the intended destination computing device 530.

The statement-of-health parameters are indicative of various criteria, such as installed applications, installed patches, configurations, device performance, hardware components and/or the like. The current statement-of-health of each computing device 520, 530 may be generated, collected or otherwise made available any number of ways. In one implementation, the current statement-of-health may be determined by the firewall application 564. In another implementation, the statement-of-health may be provided by the associated computing devices. In yet another implementation, the current statement-of-health may be received form a trusted resource, such as a statement-of-health authentication server on the internet.

In one implementation, the statement-of-health information may be stored as program data 568′ in a tabular form. The table may include a record, for each device, that contains a full-bill of health for the device. The bill of health for the device may indicate if the device is healthy or unhealthy and if the device is unhealthy what is deficient. In another implementation, the statement-of-health information may be as single value for each device. The single value may be an aggregation of all the statement-of-health criteria for a given computing device.

If the current statement-of-health indicates that the source and/or destination computing devices 520, 530 are healthy, access is allowed. If the current statement-of-health indicates that the source and/or destination computing devices 520, 530 are unhealthy, access may be denied, the request may be filtered as a function of one or more applicable network provisioning and traffic parameters, or the source computing device 520 may be pushed to a resource for updating the source computing device's 520 statement-of-health. Accordingly, it is appreciated that a statement-of-health based access policy provides fine-tuned network access protection. The network access protection provided by the statement-of-health based access policy is adapted to block only the potentially hazardous traffic while having little or no impact on users of the computing devices 520, 530.

It is appreciated that the illustrated operating architecture 500 is only one example of a suitable operating architecture and is not intended to suggest any limitations as to the scope of use or functionality of the invention. Neither should the operating architecture be interpreted as having any dependency or requirement relating to any one component or combination of components illustrated in the exemplary operating architecture 500. Other well-known computing systems, environments and/or configurations that may be suitable for use with the invention include, but are not limited to personal computers, server computers, client devices, router, switch, wireless access point, security appliance, hand-held or laptop devices, multiprocessor systems, microprocessor-base systems, set top boxes, programmable consumer electronics, network PCs, minicomputers, mainframe computers, distributed computing environments that include any of the above systems or devices, and/or the like.

Embodiments advantageously extend the current set of data used in specifying and enforcing access policies to include statement-of-health parameters of the appropriate computing devices. Accordingly, embodiments may advantageously provide cost-effective mitigation to the spread of malicious software across networks (e.g., trust boundaries). Embodiments may also advantageously contribute to the elimination of potential vulnerability inside the networks.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method comprising:
receiving a statement-of-health of a first computing device; and
controlling communications between the first computing device and a second computing device as a function of the statement-of-health of the first computing device.

2. A method according to claim 1, wherein controlling communications between the first and second computing devices further comprises selectively routing communications as a function of the statement-of-health.

3. A method according to claim 1, wherein controlling communications between the first and second computing devices further comprises allowing or denying communications between the first and second computing devices as a function of the statement-of-health of the first computing device.

4. A method according to claim 3, wherein controlling communications between the first and second computing devices further comprises redirecting communications between the first and second computing devices to a third computing device as a function of the statement-of-health of the first computing device.

5. A method according to claim 3, wherein controlling communications between the first and second computing devices further comprises filtering communications between the first and second computing devices as a function of the statement-of-health of the first computing device.

6. A method according to claim 1, further comprising:
receiving a statement-of-health of the second computing device; and
controlling communications between the first and second computing devices as a function of the statement-of-health of the second computing device.

7. A method according to claim 1, further comprising:
receiving a network provisioning or traffic parameter selected from a group consisting of a domain name of a source, a domain name of a destination, an internet protocol address of a source, an internet protocol address of a destination, a communication channel identifier, an application protocol identifier, a security credential of a source and a security credential of a destination; and
further controlling communications between the first and second computing devices as a function of the network provisioning or traffic parameter.

8. One or more computer-readable media having instructions that, when executed on one or more processors, perform acts comprising:
creating an access policy as a function of a statement-of-health based rule; and
applying the access policy to communications between a first computing device and a second computing device based upon a current statement-of-health of the first computing device.

9. One or more computer-readable media according to claim 8, wherein applying the access policy comprises selectively allowing or preventing the communications between the first and second computing devices as a function of the current statement-of-health of the first computing device.

10. One or more computer-readable media according to claim 9, wherein applying the access policy further comprises selectively pushing the first computing device to a resource for updating the first computing device's statement-of-health.

11. One or more computer-readable media according to claim 10, wherein applying the access policy further comprises selectively filtering the communications between the first and second computing devices as a function of one or more network provisioning or traffic parameters.

12. One or more computer-readable media according to claim 10, further comprising applying the access policy to communications between the first computing device and the second computing device based upon a current statement-of-health of the second computing device.

13. One or more computer-readable media according to claim 12, wherein applying the access policy further comprises selectively allowing or denying the communications between the first and second computing devices as a function of the current statement-of-health of the second computing device.

14. One or more computer-readable media according to claim 13, wherein applying the access policy further comprises selectively pushing the second computing device to a resource for updating the second computing device's statement-of-health.

15. An apparatus comprising:
a processor;
memory communicatively coupled to the processor;
a communication port, communicatively coupled to the processor, for receiving and sending communications;
wherein the apparatus is adapted to receive a current statement-of-health of a computing device associated with a communication and to route the communication according to a statement-of-health based rule and the current statement-of-health.

16. An apparatus according to claim 15, wherein the apparatus is further adapted to selectively filter the communication according to a network provisioning and traffic based rule and the current statement-of-health.

17. An apparatus according to claim 16, wherein the network provisioning and traffic based rule limits the communication as a function of one or more parameters selected from a group consisting of a domain name of a source, a domain name of a destination, an internet protocol address of a source, an internet protocol address of a destination, a communication channel identifier, an application protocol identifier, a security credential of a source and a security credential of a destination.

18. An apparatus according to claim 15, wherein the current statement-of-health comprises a state of a source computing device, a destination computing device or both.

19. An apparatus according to claim 18, wherein the current statement-of-health comprises a state of each of one or more criteria selected from a group consisting of an installed application status, an installed patch status, a configuration status, a device performance status and a presence of a hardware component.

20. An apparatus according to claim 18, wherein the current statement-of-health comprises an aggregation of a state of each of one or more criteria selected from a group consisting of an installed application status, an installed patch status, a configuration status, a device performance status and a presence of a hardware component.
